(19) United States
(12) Patent Application Publication
(10) Pub. No.: US 2004/0202053 A1
(43) Pub. Date: Oct. 14, 2004

(54) Method for time display

(75) Inventors: Wan-Yi Chen, Taipei (TW); Cheng-Han Chiang, Taipei (TW)

Correspondence Address: BROWDY AND NEIMARK, P.L.L.C., 624 NINTH STREET, NW, SUITE 300, WASHINGTON, DC, 20001-5303, US

(73) Assignee: CAL-COMP ELECTRONICS (THAILAND) PUBLIC CO., LTD., Klong Toey (TH)

(21) Appl. No.: 10/409,057

(22) Filed: Apr. 9, 2003

(51) Int. Cl. G04C 19/00

(52) U.S. Cl. 368/82

(57) ABSTRACT

A method for time display, and more particularly, a method that automatically changes the backdrop of time display according to a value of time, e.g. changing the backdrop according to hour, date, month, season, or year. Therein, the method includes: acquiring a value of time provided by a system; showing a backdrop picture according to the value of time; and displaying the value of time on the backdrop picture. Hence, the method can make time display full of variety and diversity to satisfy the recent requirements of people.

### FIELD OF THE INVENTION

The present invention is directed to a method for time display, and more particularly, to a method that automatically changes the backdrop of time display according to a value of time, e.g. changing the backdrop according to hour, date, month, season, or year.

### BACKGROUND OF THE INVENTION

In accordance with the conventional method for time display, it can be divided into two parts. One is mechanical type and the other is electronic type. Therein, the method of mechanical type displays time by using needles while the one of electronic type displays time by digit or virtual needles. With progressing of technology, the electronic type time displaying devices can be seen everywhere. It may appear on computer, mobile phone or personal digital assistant (PDA). However, the conventional method for time display usually uses only one backdrop. Hence, it is very monotonous and doesn't satisfy the recent requirement of people.

Accordingly, as discussed above, the conventional method for time display obviously still has some drawbacks that could be improved. The present invention aims to resolve the drawbacks in the prior art.

### SUMMARY OF THE INVENTION

An objective of the present invention is to provide a method for time display that changes the backdrop according to hour, date, month, season, or year.

Another objective of the present invention is to provide a device for time display that changes the backdrop according to hour, date, month, season, or year.

Still another objective of the present invention is to make time display full of variety and diversity to satisfy the recent requirement of people.

For reaching the objectives above, the present invention mainly provides a method for time display, which includes:

acquiring a value of time provided by a system;

showing a backdrop picture according to the value of time; and

displaying the value of time on the backdrop picture.

Numerous additional features, benefits and details of the present invention are described in the detailed description, which follows.

### BRIEF DESCRIPTION OF THE DRAWINGS

FIG. 1 is an operative flowchart of a method for time display complied with the present invention.

FIG. 2 shows an embodiment of the method for time display complied with the present invention.

FIGS. 3˜4 show an embodiment of a device for time display complied with the present invention.

### DETAILED DESCRIPTION

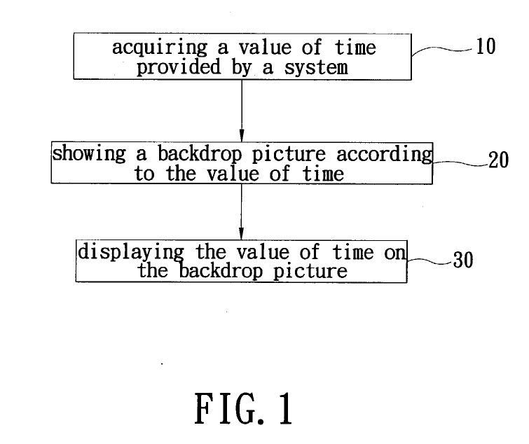

Please refer to FIG. 1, which is operative flowchart of a method for time display complied with the present invention. The method includes following steps:

Step 10: acquiring a value of time provided by a system, such as hour, date, month or year.

Step 20: showing a backdrop picture according to the value of time. For example, showing a picture with a blue sky and white clouds in the daytime or showing a picture with a moon and stars at night.

Step 30: displaying the value of time on the backdrop picture. In practice, the value time can be displayed by digit or virtual needles.

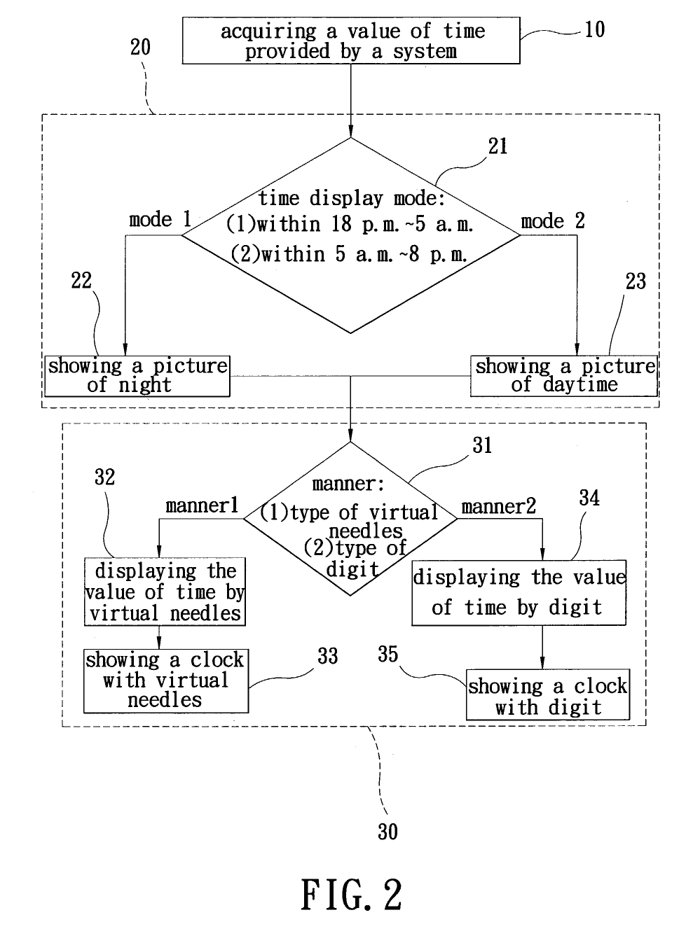

Please refer to FIG. 2, which shows a detailed embodiment of the method for time display complied with the present invention.

Step 10: acquiring a value of time provided by a system.

Step 21: determining a mode according to the value of time. If the value of time is within 18 p.m.˜5 a.m., it is the first mode and step 22 should be jumped to. Otherwise, it is the second mode and step 23 should be jumped to.

Step 22: showing a picture of night, such as a picture with moon and stars. Then, jump to step 31.

Step 23: showing a picture of daytime, such as a picture with blue sky and white clouds. Then, jump to step 31.

Step 31: determining a manner of time display according to a preset value. If the preset value corresponds to the type of virtual needles, it is the first manner and the step 32 should be jump to. If the preset value corresponds to the type of digit, it is the second manner and the step 34 should be jump to.

Step 32: displaying the value of time by virtual needles. Then, jump to step 33.

Step 33: showing a clock with virtual needles.

Step 34: displaying the value of time by digit. Then, jump to step 35.

Step 35: showing a clock with digit.

In practice, the method described above can be modified so as to determine the backdrop picture in accordance with date, month, season or year. For example, showing a picture with celebration on the National Day, or showing a picture about romance during February.

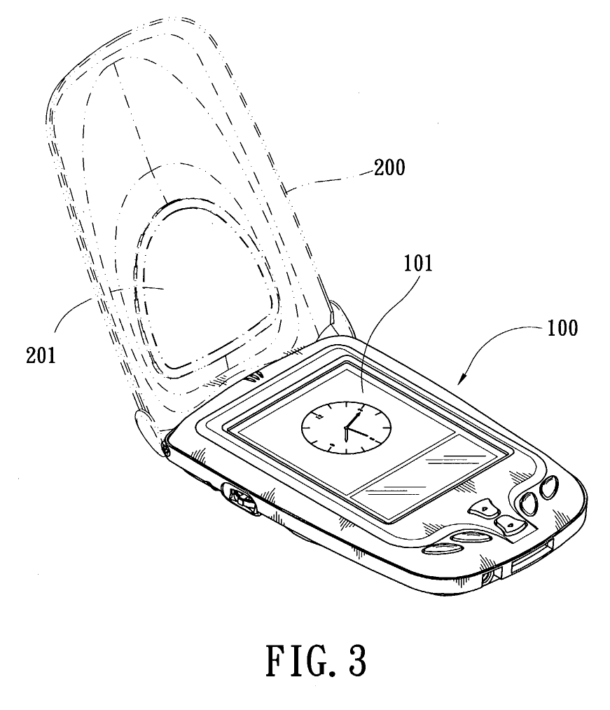

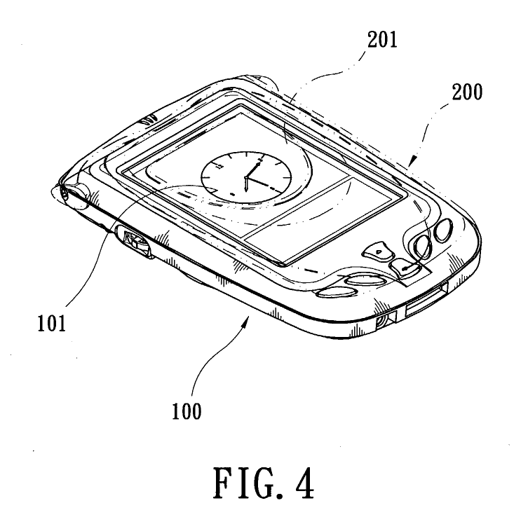

Please refer to FIG. 3, which shows an embodiment of a device for time display complied with the present invention. The device for time display includes a main body 100 and an upper cover 200. The upper cover 200 is pivoted on the main body 100. Therein, the main body further includes a screen 101 to display the time and the corresponding backdrop, and the upper cover 200 further includes a transparent portion 201.

When the device for time display is turned on, the main body 100 will automatically execute a time display program (not shown in drawings). Then, the time display program will determine the backdrop figure shown on the screen 101 according to the value of time (such as hour, date, month, season or year) and display the value of time on the backdrop figure.

As shown on FIG. 4, when the upper cover 200 covers the main body 100, a user still can read the value of time shown on the screen 101 201 and enjoy the sight of the varied backdrop via the transparent portion.

In practice, the device for time display can be a personal digital assistant (PDA) and the transparent portion 201 can be a piece of transparent glass.

In conclusion, the method for time display complied with the present invention can solve the problem of conventional time display indeed. It can make time display full of variety and diversity so as to satisfy the recent requirements of people.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A method for time display comprising:
acquiring a value of time provided by a system;
showing a backdrop picture according to the value of time; and
displaying the value of time on the backdrop picture.

2. The method as claimed in claim 1, wherein the step of showing the backdrop picture according to the value of time further comprises:
determining a time display mode according to the value of time; and
showing the backdrop picture corresponding to the time display mode.

3. The method as claimed in claim 1, wherein the step of displaying the value of time on the backdrop picture further comprises:
determining a time display manner according to a preset value; and
displaying the value of time on the backdrop picture according to the time display manner.

4. The method as claimed in claim 1, wherein the value of time is hour, date, month, season or year.

5. The method as claimed in claim 1, wherein the backdrop picture is a picture with blue sky and white clouds or with moon and stars.

6. The method as claimed in claim 1, wherein the value of time is displayed by virtual needles or a digit.

7. A device for time display, comprising a main body and an upper cover, said upper cover being pivoted on one end of said main body; said main body further having a screen and a time display program, said main body display a value of time and a corresponding backdrop on the screen by executing the time display program; and said upper cover further having a transparent portion, hence, the value of time and backdrop able to be viewed by a user via the transparent portion.

8. The device as claimed in claim 7, wherein the main body is a personal digital assistant (PDA).

9. The device as claimed in claim 7, wherein the transparent portion is a piece of transparent glass.
